(19) United States
(12) Patent Application Publication
(10) Pub. No.: US 2026/0196652 A1
(43) Pub. Date: Jul. 9, 2026

(54) CAP PLATE COVER FOR A BATTERY CELL ASSEMBLY

(71) Applicant: GM Global Technology Operations LLC, Detroit, MI (US)

(72) Inventors: Arturo Sanchez Perez, Rochester Hills, MI (US); S M Qudrot E Elahi Faisal, Novi, MI (US); Saurabh Bahuguna, Novi, MI (US); Srikant Srinivasan, Novi, MI (US)

(21) Appl. No.: 19/010,647

(22) Filed: Jan. 6, 2025

(51) Int. Cl. H01M 50/358; B60L 50/64; H01M 50/103; H01M 50/119; H01M 50/15; H01M 50/157; H01M 50/159

(52) U.S. Cl. CPC H01M 50/358; B60L 50/64; H01M 50/103; H01M 50/119; H01M 50/15; H01M 50/157; H01M 50/159; H01M 2200/20; H01M 2220/20

(57) ABSTRACT

A battery cell assembly includes a cell cap header having an outer perimeter and an outer surface. The outer surface of the cell cap header defines a pressure vent. The battery cell assembly also includes a housing that is constructed of a housing material. The housing includes a base surface, at least one side surface, and an opening. The at least one side surface connects the base surface with the opening of the housing. The battery cell assembly includes a cap plate cover constructed of a cell cap plate material and positioned to cover at least a portion of the outer surface of the cell cap header. The cap plate cover defines a top plate including a vent opening shaped to correspond with the pressure vent. A melt temperature of the cell cap plate material is greater than a melt temperature of the housing material.

### INTRODUCTION

The present disclosure relates to a cap plate cover for a battery cell assembly that is part of a battery module.

Rechargeable energy storage system (RESS) may be employed in a variety of applications. For example, a vehicle may include a rechargeable battery pack to power one or more electric motors that provide motive power to the vehicle. A battery pack includes a plurality of battery cells, where each individual battery cell includes a pressure vent located along its upper surface. During standard operating conditions, the pressure vent remains sealed. However, when a battery cell undergoes stress due to events such as thermal runaway, chemical reactions within the battery cell may produce gases. As the gases accumulate, the battery cell's internal pressure rises. When the internal pressure of the battery cell exceeds a predefined limit, the pressure vent opens to release the built-up gases.

It is to be appreciated that in some instances the built-up gases released from the pressure vent may become hot enough to melt the outer housing of the battery cell in the area where the pressure vent is located. This may cause the built-up gases to exit along an unintended area of the battery cell, such as along an edge of the pressure vent. If this occurs, then the built-up gases may travel underneath a thermal sheet disposed along the upper surface of the battery cells. The built-up gases trapped underneath the thermal sheet may unintentionally heat an adjacent battery cell, which may accelerate thermal runaway propagation.

Thus, while existing battery cells achieve their intended purpose, there is a need in the art for an improved approach for venting gases within a battery cell.

### SUMMARY

According to several aspects, a battery cell assembly is disclosed and includes a cell cap header having an outer perimeter and an outer surface, where the outer surface of the cell cap header defines a pressure vent. The battery cell assembly also includes a housing constructed of a housing material, the housing including a base surface, at least one side surface, and an opening, wherein the at least one side surface connects the base surface with the opening of the housing. The opening of the housing is shaped to correspond with the outer perimeter of the cell cap header. The battery cell assembly also includes a cap plate cover constructed of a cell cap plate material and positioned to cover at least a portion of the outer surface of the cell cap header, where the cap plate cover defines a top plate including a vent opening shaped to correspond with the pressure vent of the cell cap header, and where a melt temperature of the cell cap plate material is greater than a melt temperature of the housing material.

In another aspect, the cap plate cover includes a skirt portion that extends in a downward direction from the top plate.

In yet another aspect, the skirt portion of the cap plate cover surrounds at least a portion of the at least one side surface of the housing.

In an aspect, the skirt portion of the cap plate cover completely surrounds all side surfaces of the housing.

In another aspect, the skirt portion of the cap plate cover includes a height measured from the top plate to a bottom edge of the cap plate cover.

In yet another aspect, the battery cell assembly is a prismatic battery cell.

In an aspect, the housing material is aluminum.

In another aspect, the cell cap plate material includes at least one of the following: steel, a composite material, ceramic, and mica.

In an aspect, the cap plate cover includes a manifold disposed around the vent opening.

In another aspect, the manifold includes a wall that is perpendicular with respect to the outer surface of the cell cap header.

In yet another aspect, the manifold includes a wall having a first section that projects upwardly in a vertical direction and a second section disposed along a perimeter of the first section of the wall.

In an aspect, the second section of the wall is angled with respect to the first section of the wall to direct built-up gases released from the pressure vent in a predetermined direction.

In another aspect, the cap plate cover is secured to the housing based on one or more of the following: a press fit between the cap plate cover and the housing, an adhesive, one or more welds, and an overmold.

In yet another aspect, a battery cell assembly is disclosed and includes a cell cap header having an outer perimeter and an outer surface, wherein the outer surface of the cell cap header defines a pressure vent. The battery cell assembly includes a housing constructed of a housing material, the housing including a base surface, at least one side surface, and an opening, wherein the at least one side surface connects the base surface with the opening of the housing. The opening of the housing is shaped to correspond with the outer perimeter of the cell cap header. The battery cell assembly also includes a cap plate cover constructed of a cell cap plate material and positioned to cover at least a portion of the outer surface of the cell cap header, where the cap plate cover defines a top plate and a skirt portion that extends in a downward direction from the top plate. The top plate includes a vent opening shaped to correspond with the pressure vent of the cell cap header and the skirt portion of the cap plate cover surrounds at least a portion of the at least one side surface of the housing, and where a melt temperature of the cell cap plate material is greater than a melt temperature of the housing material.

In another aspect, the housing material is aluminum.

In yet another aspect, the cell cap cover material includes at least one of the following: steel, a composite material, ceramic, and mica.

In an aspect, the cap plate cover includes a manifold disposed around the vent opening.

In another aspect, the manifold includes a wall that is perpendicular with respect to the outer surface of the cell cap header.

In yet another aspect, the manifold includes a wall having a first section that projects upwardly in a vertical direction and a second section disposed along a perimeter of the first section of the wall.

In an aspect, a battery pack providing power to one or more electric motors that are part of a vehicle. The battery pack includes a battery enclosure containing a plurality of battery cell assemblies. Each battery cell assembly includes a cell cap header constructed of a cell cap header material and having an outer perimeter and an outer surface, where the outer surface of the cell cap header defines a pressure vent. Each battery cell also includes a housing constructed of a housing material, the housing including a base surface, at least one side surface, and an opening, where the at least one side surface connects the base surface with the opening of the housing. The opening of the housing is shaped to correspond with the outer perimeter of the cell cap header, and a melt temperature of the cell cap header material is greater than a melt temperature of the housing material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including a battery pack having a plurality of battery cell assemblies, according to an exemplary embodiment;

FIG. 2 is a perspective view of one of the battery cell assemblies shown in FIG. 1, where the battery cell assembly includes a battery cell and a cap plate cover, according to an exemplary embodiment;

FIG. 3 is an assembly view of the battery cell assembly shown in FIG. 2, according to an exemplary embodiment;

FIG. 4 is a perspective view of an alternative embodiment of the cap plate cover, according to an exemplary embodiment;

FIG. 5 is a side view of the cap plate cover shown in FIG. 3, where a manifold is visible, according to an exemplary embodiment;

FIG. 6 illustrates a plurality of the battery cell assemblies that are positioned adjacent to one another within the battery enclosure shown in FIG. 1, according to an exemplary embodiment;

FIG. 7 is an alternative embodiment of the manifold shown in FIG. 5, according to an exemplary embodiment;

FIG. 8A is a perspective view of the battery cell assembly including two heat stakes, according to an exemplary embodiment; and

FIG. 8B is a perspective view of the battery cell assembly including an overmold around the terminals, according to an exemplary embodiment.

### DETAILED DESCRIPTION

The following description is merely exemplary in nature and is not intended to limit the present disclosure, application, or uses.

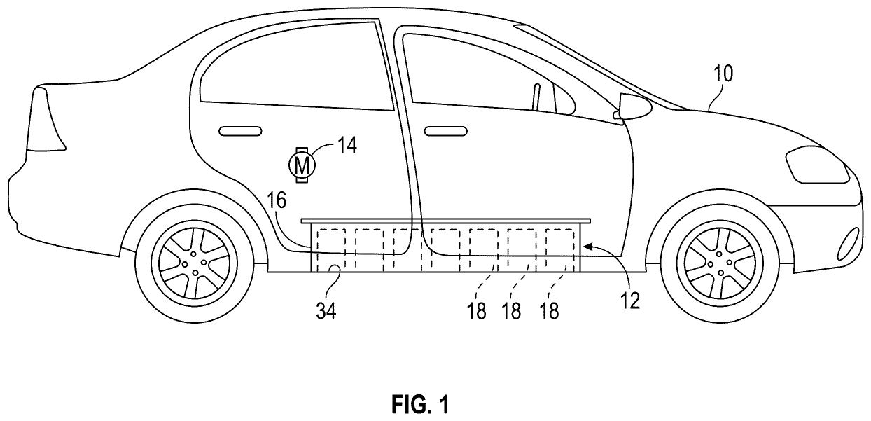

Referring to FIG. 1, a schematic diagram of a vehicle 10 including an exemplary battery pack 12 for providing power to one or more electric motors 14 is illustrated. It is to be appreciated that although the vehicle 10 is illustrated as a sedan, the vehicle 10 may be any other type of vehicle such as, but not limited to, a truck, sport utility vehicle, van, or motor home. The battery pack 12 includes a battery enclosure 16 that contains a plurality of battery cell assemblies 18 that are electrically connected to one another. Although a vehicle 10 is described and illustrated in FIG. 1, it is to be appreciated that the battery pack 12 is not limited to a vehicle and may be employed in other rechargeable energy storage system (RESS) applications as well.

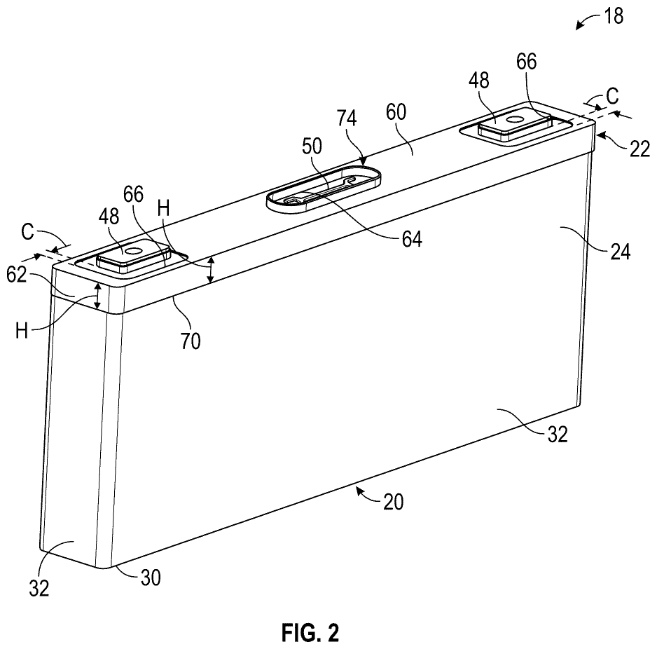

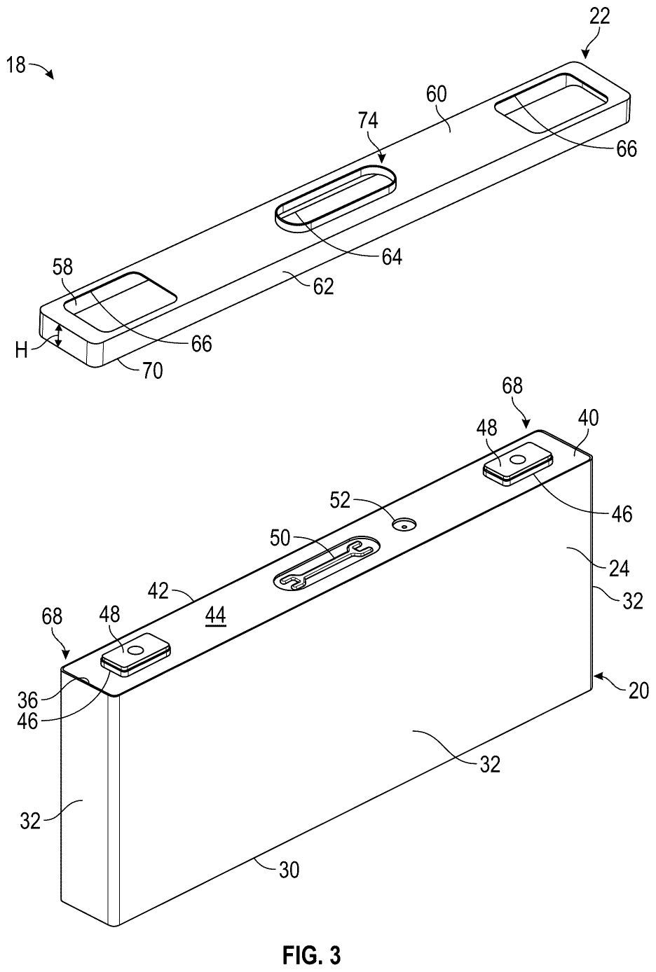

FIG. 2 is a perspective view of one embodiment of one of the battery cell assemblies 18 shown in FIG. 1. The battery cell assembly 18 includes a battery cell 20 and a cap plate cover 22. FIG. 3 is an assembly view of the battery cell assembly 18 shown in FIG. 2, where the cap plate cover 22 is separated from the battery cell 20. Referring to both FIGS. 2 and 3, the battery cell 20 includes an outer shell or housing 24 containing the anode, the cathode, and separator plates (not visible in the figures) as well as a cell cap header 40 (visible in FIG. 3). In the non-limiting embodiment as shown in the figures, the battery cell assembly 18 is a prismatic battery cell where the housing 24 includes a substantially rectangular or square profile. However, it is to be appreciated that the present disclosure is not limited to prismatic battery cells. Indeed, in another embodiment, the battery cell 20 may be a cylindrical cell instead.

Referring specifically to FIG. 3, the housing 24 of the battery cell 20 includes a base surface 30, at least one side surface 32, and an opening 36, where the at least one side surface 32 connects the base surface 30 with the opening 36 of the housing 24. In the non-limiting embodiment as shown in FIG. 3, the housing 24 includes a rectangular profile including four side surfaces 32 (i.e., the front, back, left, and right side surfaces 32). However, it is to be appreciated that the housing 24 is not limited to four side surfaces 32. For example, in an embodiment where the battery cell 20 is cylindrical cell, then the side surface 32 of the housing 24 is a singular curved surface. Referring to FIGS. 1 and 3, the base surface 30 of the housing 24 of the battery cell 20 is seated upon a support surface 34 of the battery enclosure 16 when installed in the vehicle 10. The housing 24 of the battery cell 20 is constructed of a housing material. In one embodiment, the housing material is aluminum.

Referring to FIGS. 2 and 3, the cell cap header 40 defines an an outer perimeter 42 and an outer surface 44. The opening 36 of the housing 24 of the battery cell 20 is shaped to correspond with the outer perimeter 42 of the cell cap header 40 that is part of the battery cell assembly 18. The outer surface 44 of the cell cap header 40 defines a pair of openings 46 for receiving a pair of terminals 48 of the battery cell assembly 18. Specifically, the cell cap header 40 includes left and right of end portions 68, where one of the terminals 48 of the battery cell assembly 18 is disposed upon the right end portion 68 of the cell cap header 40 and the remaining terminal 48 of the battery cell assembly 18 is disposed on the left end portion 68 of the cell cap header 40. In an embodiment, the cell cap header 40 is constructed of a cell cap header material such as, but not limited to, aluminum.

In one non-limiting embodiment, the cap plate cover 22 is omitted from the battery cell assembly 18. Instead, the cell cap header 40 is constructed of a cell cap header material including a melt temperature that is greater than a melt temperature of the housing material. In one embodiment, the cell cap header material is at least one of the following: steel, a composite material, ceramic or mica. It is also to be appreciated that the melt temperature of the cell cap header material is selected so that the cell cap header 40 remains intact and does not substantially melt during a thermal runaway event of the battery cell assembly 18. In other words, the cell cap header material is selected to withstand the temperatures that are produced during a thermal runaway event of the battery cell assembly 18. Accordingly, the pressure vent 50 of the cell cap header 40 remains functional during a thermal runaway event.

The outer surface 44 of the cell cap header 40 also defines a pressure vent 50 and an electrolyte opening 52. During standard operating conditions, the pressure vent 50 remains in a closed position. When an internal pressure of the battery cell 20 exceeds a predefined limit, the pressure vent 50 opens to release built-up gases that accumulate within the battery cell 20. When the cap plate cover 22 is removed, the outer surface 44 of the cell cap header 40 is exposed.

The cap plate cover 22 is positioned to cover at least a portion of the outer surface 44 of the cell cap header 40. The cap plate cover 22 is constructed of a cell cap plate material. It is to be appreciated that the cell cap plate material includes a melt temperature that is greater than a melt temperature of the housing material. In one embodiment, the cell cap plate material is at least one of the following: steel, a composite material, ceramic or mica. It is also to be appreciated that the melt temperature of the cell cap plate material is selected so that the cap plate cover 22 remains intact and does not substantially melt during a thermal runaway event of the battery cell assembly 18. In other words, the cell cap plate material is selected to withstand the temperatures that are produced during a thermal runaway event of the battery cell assembly 18. Accordingly, the pressure vent 50 of the cell cap header 40 remains functional during a thermal runaway event.

The cap plate cover 22 defines a top plate 60 and a skirt portion 62. When the cap plate cover 22 is assembled to the housing 24 of the battery cell 20, the top plate 60 of the cap plate cover 22 abuts against at least a portion of the outer surface 44 of the cell cap header 40. The top plate 60 of the cap plate cover 22 defines a vent opening 64 that is shaped to correspond with the pressure vent 50 of the cell cap header 40. That is, when the cap plate cover 22 is assembled to the housing 24 of the battery cell 20, the pressure vent 50 is visible through the vent opening 64 of the cap plate cover 22. The top plate 60 of the cap plate cover 22 also defines terminal openings 66 that are shaped to receive one of the terminals 48 of the battery cell assembly 18.

Referring to FIG. 3, the cap plate cover 22 also defines an inner surface 58 that opposes the outer surface 44 of the cell cap header 40 and the housing 24 of the battery cell assembly 18. In embodiments, the inner surface 58 of the cap plate cover 22 may be coated with an internal coating or a plastic overmold that provides electrical insulation.

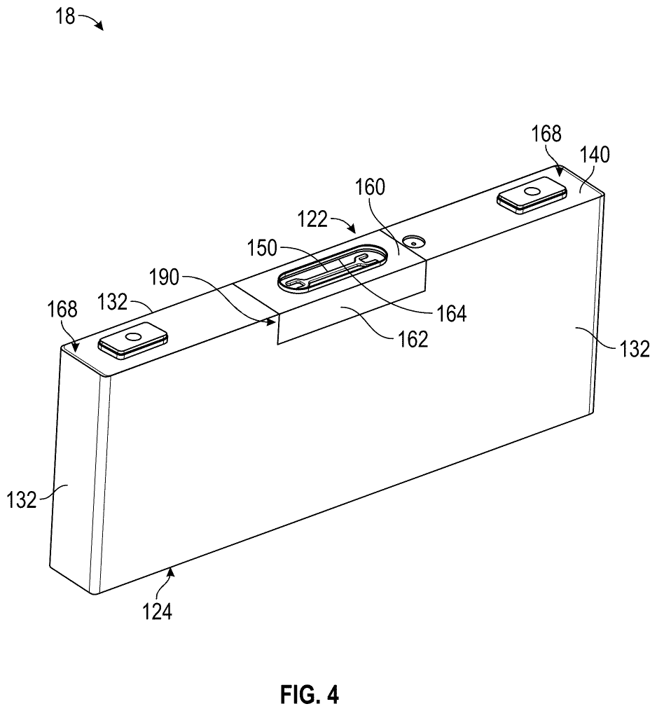

In the embodiment as shown in FIGS. 2 and 3 the top plate 60 of the cap plate cover 22 covers a majority of the outer surface 44 of the cell cap header 40, excluding the pressure vent 50. For example, as seen in FIG. 2, in embodiments a nominal amount of clearance C may be located between the terminal openings 66 of the cap plate cover 22 and the terminal 48 of the battery cell assembly 18. However, as shown in FIG. 4 and as described below, in another embodiment the top plate 160 of the cap plate cover 122 only covers an area 190 of the cell cap header 140 immediately surrounding the pressure vent 150. This is because the area 190 of the cell cap header 140 represents an area having the highest propensity for melting during a thermal runaway event when compared to the remaining portion of the battery cell assembly 18.

Referring back to FIGS. 2 and 3, the skirt portion 62 extends in a downward direction from the top plate 60 of the cap plate cover 22 and surrounds at least a portion of the at least one side surface 32 of the housing 24. In the embodiment as shown in FIGS. 2 and 3, the skirt portion 62 of the cap plate cover 22 completely surrounds all of the side surfaces 32 of the housing 24. However, as shown in FIG. 4, in another embodiment the skirt portion 162 of the cap plate cover 22 surrounds only a portion of the at least one side surface 132 of the housing 124.

As seen in FIGS. 2 and 3, the skirt portion 62 of the cap plate cover 22 includes a height H measured from the top plate 60 to a bottom edge 70 of the cap plate cover 22. It is to be appreciated that the height H of the skirt portion 62 of the cap plate cover 22 is based on a thermal or heat conducting profile of the housing 24 during a thermal runaway event. Additionally, the height H of the skirt portion 62 of the cap plate cover 22 is based on a specific retention mechanism that is employed for securing the cap plate cover 22 to battery cell assembly 18, which is described below and shown in FIGS. 8A and 8B.

FIG. 4 is an alternative embodiment of the cap plate cover 122. In the embodiment as shown in FIG. 4, the cap plate cover 122 only covers an area 190 of the cell cap header 140 immediately surrounding the pressure vent 150, and the skirt portion 162 of the cap plate cover 122 surrounds only a portion of the at least one side surface 32 of the housing 124. As seen in FIG. 4, the top plate 160 of the cap plate cover 122 defines a vent opening 164 that is shaped to correspond with the pressure vent 150 of the cell cap header 140, however, both the left and right end portions 168 of the cell cap header 140 are exposed and not covered by the cap plate cover 122. In embodiments, the skirt portion 162 of the cap plate cover 122 surrounds portions of the side surfaces 132 of the housing 124 having the highest propensity for melting during a thermal runaway event when compared to the remaining portion of the housing 124. In the embodiment as shown in FIG. 4, the skirt portion 162 of the cap plate cover 122 surrounds a portion of a front side surface 132 of the housing 124 directly adjacent to the pressure vent 150. The skirt portion 162 of the cap plate cover 122 also surrounds a portion of a rear side surface 132 of the housing 124 (not visible in the figures) directly adjacent to the pressure vent 150 as well. It is to be appreciated that the cap plate cover 122 shown in FIG. 4 results in reduced weight and material.

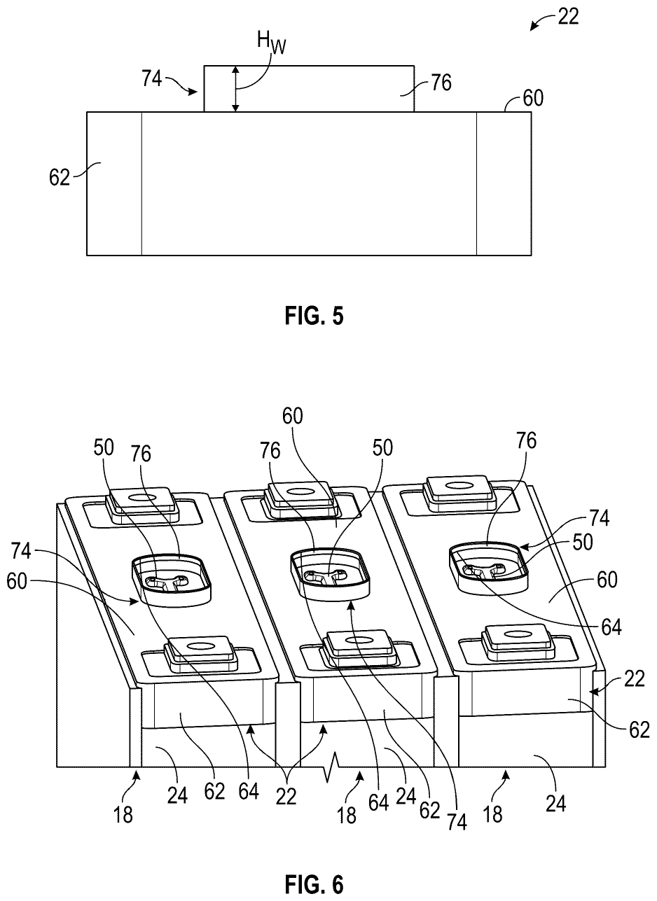

Referring to FIGS. 2 and 3, in one embodiment the cap plate cover 22 may include a manifold 74 disposed around the vent opening 64 of the cap plate cover 22. FIG. 5 is a side view of the cap plate cover 22, where the manifold 74 is visible. FIG. 6 illustrates a plurality of the battery cell assemblies 18 that are positioned adjacent to one another within the battery enclosure 16 (FIG. 1).

Referring to FIGS. 2 and 5-6, the manifold 74 of the cap plate cover 22 includes a wall 76. The wall 76 of the manifold 74 is shaped to redirect the flow of the built-up gases that are released from the pressure vent 50. Referring specifically to FIG. 6, the manifold 74 may also substantially prevent particles that escape from the pressure vent 50 of one of the battery cell assemblies 18 from migrating to an adjacent battery cell assembly 18. In the embodiment as shown in FIGS. 2 and 5-6, the wall 76 of the manifold 74 projects upwardly in a vertical direction. That is, referring specifically to FIGS. 3 and 5, the wall 76 of the manifold 74 is perpendicular with respect to the outer surface 44 of the cell cap header 40. The wall 76 of the manifold 74 also includes a wall height H_{W}, where the wall height H_{W} of the wall 76 is determined based on a location where the built-up gases released from the pressure vent 50 are directed towards.

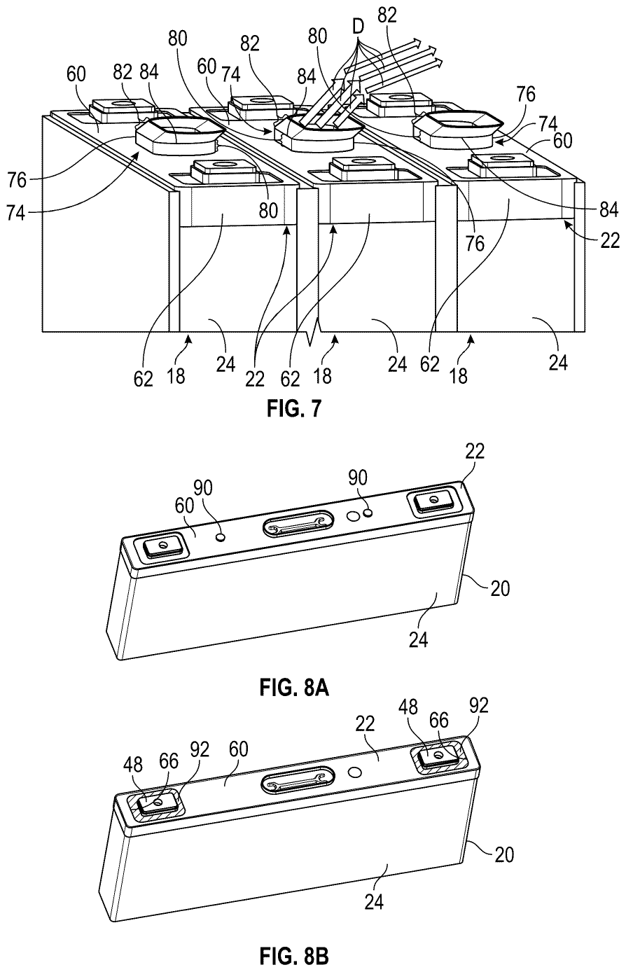

Although FIGS. 2 and 5-6 illustrate the wall 76 of the manifold 74 oriented upwardly in a vertical direction and perpendicular with respect to the outer surface 44 of the cell cap header 40 (FIG. 3), in another embodiment at least a portion of the wall 76 of the manifold 74 is angled. For example, FIG. 7 illustrates a plurality of the battery cell assemblies 18 positioned adjacent to one another, where the cap plate cover 22 includes a manifold 74 having a wall 76 having a first section 80 that projects upwardly in a vertical direction and a second section 82 that is disposed along a perimeter 84 of the first section 80 of the wall 76. Referring to FIGS. 3 and 7, the first section 80 of the wall 76 of the manifold 74 is perpendicular with respect to the outer surface 44 of the cell cap header 40, while the second section 82 of the wall 76 is angled with respect to the first section 80 of the wall 76 to direct the built-up gases released from the pressure vent 50 (visible in FIG. 3) in a predetermined direction D. In the embodiment as shown in FIG. 7, the built-up gases are directed in the predetermined direction D above and away from an adjacent battery cell assembly 18.

Referring back to FIGS. 2 and 3, the cap plate cover 22 may be secured to the housing 24 based on a variety of retention mechanisms. In one embodiment, the retention mechanism is a press fit between the cap plate cover 22 and the housing 24 of the battery cell 20. In another embodiment, the retention mechanism is an adhesive that that applied between the cap plate cover 22, the housing 24, and the cell cap header 40 of the battery cell 20. In yet another embodiment, the retention mechanism is one or more welds between the cap plate cover 22, the housing 24, and the cell cap header 40 of the battery cell 20. As an example, the cap plate cover 22 is welded to the housing 24 and/or the cell cap header 40 based on friction welding or laser welding. Referring to FIG. 8A, in still another embodiment, the retention mechanism is one or more heat stake points 90 between the cap plate cover 22 and the cell cap header 40 (seen in FIG. 3) of the battery cell 20. Referring to FIG. 8B, in another embodiment, the retention mechanism is an overmold 92 that is disposed between the terminal opening 66 disposed along the top plate 60 of the cap plate cover 22 and the terminals 48 of the battery cell assembly 18.

Referring generally to the figures, the disclosed cap plate cover provides various technical effects and benefits. Specifically, the cap plate cover provides a mechanism for substantially preventing the built-up gases that exit the battery cell from exiting the cell cap header in untended locations when battery cell assembly experiences elevated temperatures. Instead, the cap plate cover remains intact and does not substantially melt during a thermal runaway event of the battery cell assembly. As a result, the pressure vent of the cell cap header remains functional during the thermal runaway event, thereby allowing the built-up gases to exit the battery cell through the pressure vent. It is also to be appreciated that the cap plate cover also acts as a heat sink that allows for excess heat to flow from the housing to to cap plate cover.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell assembly, comprising:
a cell cap header having an outer perimeter and an outer surface, wherein the outer surface of the cell cap header defines a pressure vent;
a housing constructed of a housing material, the housing including a base surface, at least one side surface, and an opening, wherein the at least one side surface connects the base surface with the opening of the housing, and wherein the opening of the housing is shaped to correspond with the outer perimeter of the cell cap header; and
a cap plate cover constructed of a cell cap plate material and positioned to cover at least a portion of the outer surface of the cell cap header, wherein the cap plate cover defines a top plate including a vent opening shaped to correspond with the pressure vent of the cell cap header, and wherein a melt temperature of the cell cap plate material is greater than a melt temperature of the housing material.

2. The battery cell assembly of claim 1, wherein the cap plate cover includes a skirt portion that extends in a downward direction from the top plate.

3. The battery cell assembly of claim 2, wherein the skirt portion of the cap plate cover surrounds at least a portion of the at least one side surface of the housing.

4. The battery cell assembly of claim 2, wherein the skirt portion of the cap plate cover completely surrounds all side surfaces of the housing.

5. The battery cell assembly of claim 2, wherein the skirt portion of the cap plate cover includes a height measured from the top plate to a bottom edge of the cap plate cover.

6. The battery cell assembly of claim 1, wherein the battery cell assembly is a prismatic battery cell.

7. The battery cell assembly of claim 1, wherein the housing material is aluminum.

8. The battery cell assembly of claim 1, wherein the cell cap plate material includes at least one of the following: steel, a composite material, ceramic, and mica.

9. The battery cell assembly of claim 1, wherein the cap plate cover includes a manifold disposed around the vent opening.

10. The battery cell assembly of claim 9, wherein the manifold includes a wall that is perpendicular with respect to the outer surface of the cell cap header.

11. The battery cell assembly of claim 9, wherein the manifold includes a wall having a first section that projects upwardly in a vertical direction and a second section disposed along a perimeter of the first section of the wall.

12. The battery cell assembly of claim 11, wherein the second section of the wall is angled with respect to the first section of the wall to direct built-up gases released from the pressure vent in a predetermined direction.

13. The battery cell assembly of claim 1, wherein the cap plate cover is secured to the housing based on one or more of the following: a press fit between the cap plate cover and the housing, an adhesive, one or more welds, and an overmold.

14. A battery cell assembly, comprising:
a cell cap header having an outer perimeter and an outer surface, wherein the outer surface of the cell cap header defines a pressure vent;
a housing constructed of a housing material, the housing including a base surface, at least one side surface, and an opening, wherein the at least one side surface connects the base surface with the opening of the housing, and wherein the opening of the housing is shaped to correspond with the outer perimeter of the cell cap header; and
a cap plate cover constructed of a cell cap plate material and positioned to cover at least a portion of the outer surface of the cell cap header, wherein the cap plate cover defines a top plate and a skirt portion that extends in a downward direction from the top plate, wherein the top plate includes a vent opening shaped to correspond with the pressure vent of the cell cap header and the skirt portion of the cap plate cover surrounds at least a portion of the at least one side surface of the housing, and wherein a melt temperature of the cell cap plate material is greater than a melt temperature of the housing material.

15. The battery cell assembly of claim 14, wherein the housing material is aluminum.

16. The battery cell assembly of claim 14, wherein the cell cap cover material includes at least one of the following: steel, a composite material, ceramic, and mica.

17. The battery cell assembly of claim 14, wherein the cap plate cover includes a manifold disposed around the vent opening.

18. The battery cell assembly of claim 17, wherein the manifold includes a wall that is perpendicular with respect to the outer surface of the cell cap header.

19. The battery cell assembly of claim 18, wherein the manifold includes a wall having a first section that projects upwardly in a vertical direction and a second section disposed along a perimeter of the first section of the wall.

20. A battery pack providing power to one or more electric motors that are part of a vehicle, the battery pack comprising:
a battery enclosure containing a plurality of battery cell assemblies, wherein each battery cell assembly includes:
a cell cap header constructed of a cell cap header material and having an outer perimeter and an outer surface, wherein the outer surface of the cell cap header defines a pressure vent; and
a housing constructed of a housing material, the housing including a base surface, at least one side surface, and an opening, wherein the at least one side surface connects the base surface with the opening of the housing, and wherein the opening of the housing is shaped to correspond with the outer perimeter of the cell cap header, and wherein a melt temperature of the cell cap header material is greater than a melt temperature of the housing material.
